(19) United States
(12) Patent Application Publication
(10) Pub. No.: US 2026/0316952 A1
(43) Pub. Date: Oct. 15, 2026

(54) AIRCRAFT INSTRUMENT PANEL INTEGRATING AT LEAST ONE SIMPLIFIED MOBILE TRAY, AIRCRAFT COMPRISING SUCH AN INSTRUMENT PANEL

(71) Applicant: Airbus Operations SAS, TOULOUSE (FR)

(72) Inventors: Sébastien PELLIZZON, TOULOUSE (FR); Mounir LAMRABTI, TOULOUSE (FR); Paul LEROY, TOULOUSE (FR); Benoît COUROUBLE, TOULOUSE (FR)

(21) Appl. No.: 19/640,934

(22) Filed: Apr. 7, 2026

(30) Foreign Application Priority Data
Apr. 9, 2025 (FR) FR2503780

(51) Int. Cl. B64D 43/00

(52) U.S. Cl. CPC B64D 43/00

(57) ABSTRACT

An aircraft instrument panel which has at least one mobile tray configured to move between retracted and deployed positions, at least one tray support connected to the instrument panel on either side of the mobile tray, the instrument panel and/or the tray support being configured to house the mobile tray at least in the retracted position, at least one guide system interposed between the mobile tray and the tray support, and at least one locking/unlocking system configured to hold the mobile tray in at least one position, from amongst the deployed positioned and the retracted position. Also an aircraft with such a panel.

### CROSS-REFERENCES TO RELATED APPLICATIONS

This application claims the benefit of French Patent Application Number FR2503780, filed on Apr. 9, 2025, the entire disclosure of which is incorporated herein by way of reference.

### FIELD OF THE INVENTION

The present application relates to an aircraft instrument panel which integrates at least one simplified mobile tray and an aircraft comprising such an instrument panel.

### BACKGROUND OF THE INVENTION

According to one configuration, an aircraft instrument panel comprises a tray in front of each pilot seat and which is mobile between a retracted position and a deployed position. In this last-mentioned position the tray is located above the seat cushion of the pilot seat.

In the deployed position, the tray is configured to be used as a support for a meal tray or a keyboard, for example. The tray is designed to enable the pilot to rest thereon.

According to one embodiment of the prior art, the mobile tray comprises more than 150 assembled parts and has a complex kinematic system. As a result, this type of mobile tray is relatively heavy and has a relatively high manufacturing cost.

### SUMMARY OF THE INVENTION

The present invention aims to remedy all or some of the drawbacks of the prior art.

To this end, the subject of the invention is an aircraft instrument panel comprising at least one lower face and at least one mobile tray configured to move parallel to a longitudinal direction between a retracted position in which the mobile tray is virtually integrally positioned below the lower face of the instrument panel and a deployed position in which the mobile tray protrudes relative to the instrument panel.

According to the invention, the instrument panel comprises:
at least one tray support connected to the instrument panel on either side of the mobile tray, the lower face of the instrument panel and/or the tray support being configured to house the mobile tray at least in the retracted position,
at least one guide system positioned below the mobile tray and interposed between said mobile tray and the tray support.
at least one locking/unlocking system configured to hold the mobile tray in at least one position, from amongst the deployed position and the retracted position.

In addition, the locking/unlocking system comprises:
a bolt which is mobile between the extended and returned positions and integral with the mobile tray,
a control unit which is configured to control the position of the bolt,
at least one spring to hold the bolt in the extended position;
a second housing or a second stop integral with the tray support and configured to cooperate with the bolt in the extended position when the mobile tray is in the deployed position;
a catch which has a lower edge provided with a notch and a stop, the catch pivoting between a contact position in which the lower edge of the catch is in contact with the stop such that the notch forms the second housing with the stop and a spaced-apart position in which the lower edge of the catch is spaced apart from the stop;
at least one spring configured to pivot the catch toward the contact position and to hold it in this position.

According to the invention, the instrument panel and its guide and locking/unlocking systems comprise a smaller number of parts and have simplified kinematic systems, which tends to reduce their mass and their manufacturing cost.

A further subject of the invention is an aircraft comprising at least one instrument panel according to one of the preceding features.

### BRIEF DESCRIPTION OF THE DRAWINGS

Further features and advantages will be found in the following description of the invention, the description being provided solely by way of example with reference to the accompanying drawings, in which:

FIG. 1 is a schematic view of a cockpit of an aircraft illustrating an embodiment of the invention,

FIG. 2 is a perspective view of a mobile tray illustrating a first embodiment of the invention,

FIG. 3 is a front view of the mobile tray visible in FIG. 2,

FIG. 4A is a side view of the mobile tray visible in FIG. 2 in the retracted position,

FIG. 4B is a side view of the mobile tray visible in FIG. 2 in the deployed position,

FIG. 5 is a perspective view of the mobile tray visible in FIG. 2 in the dismantled state,

FIG. 6 is a perspective view of a locking/unlocking system of the mobile tray visible in FIG. 2,

FIG. 7 is a perspective view of a part of the locking/unlocking system visible in FIG. 6,

FIG. 8 is a perspective view of the mobile tray visible in FIG. 2 in the retracted position,

FIG. 9 is a perspective view of the mobile tray visible in FIG. 2 in the deployed position,

FIG. 10 is a perspective view from above of a mobile tray illustrating a second embodiment of the invention,

FIG. 11 is a perspective view from below of the mobile tray visible in FIG. 10,

FIG. 12 is a perspective view of a locking/unlocking system of the mobile tray visible in FIG. 10.

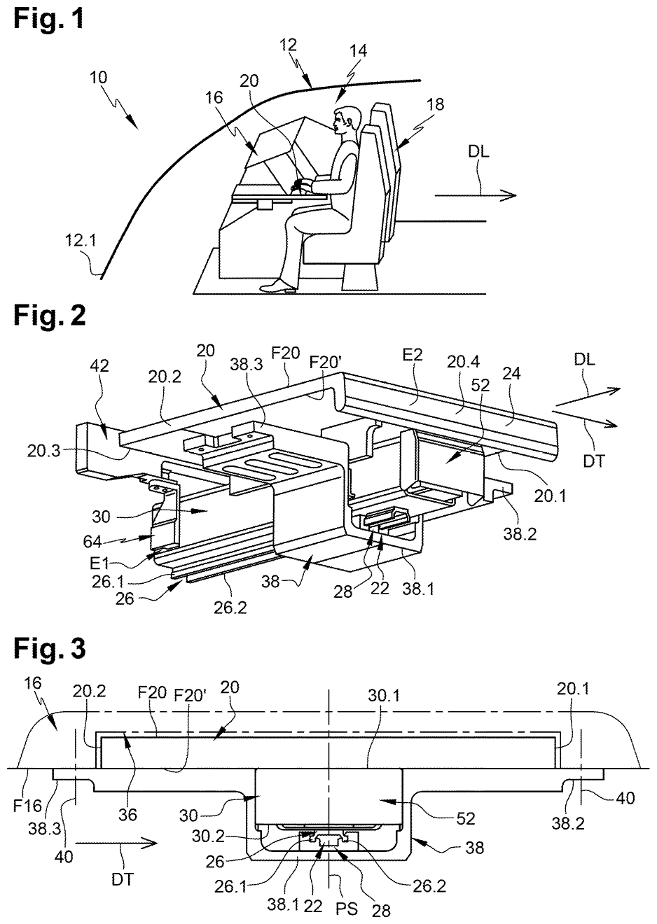

### DETAILED DESCRIPTION OF THE PREFERRED EMBODIMENTS

According to one embodiment, an aircraft 10 comprises a fuselage 12 which extends in a longitudinal direction DL between a front end 12.1 and a tail end. The aircraft comprises a cockpit 14 which is located in the region of the front end 12.1 and which has at least one instrument panel 16 and at least one pilot seat 18 positioned opposite the instrument panel 16 and offset toward the tail end relative to the instrument panel 16. According to one configuration, the cockpit 14 comprises two pilot seats 18 offset in a transverse direction DT perpendicular to the longitudinal direction DL.

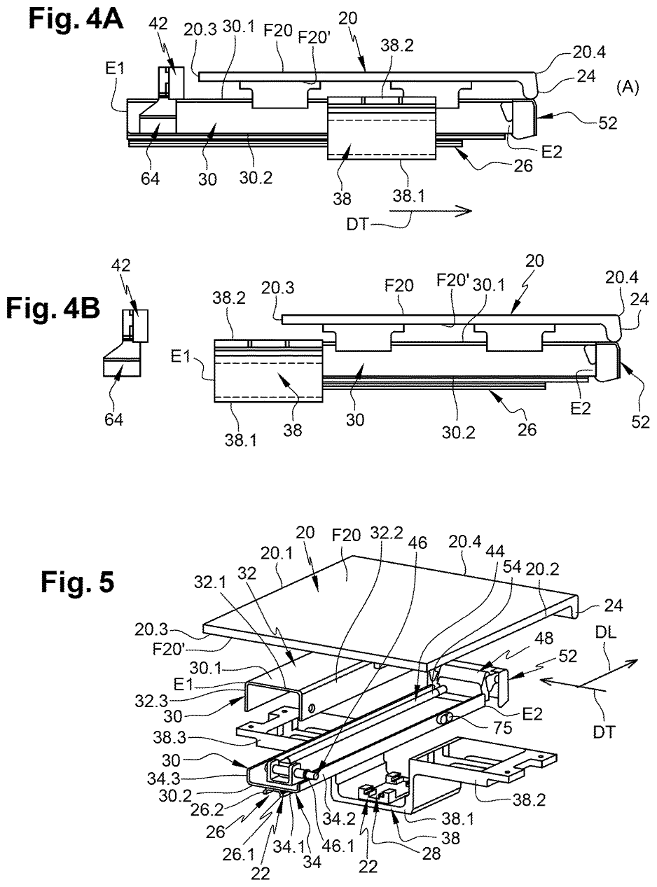

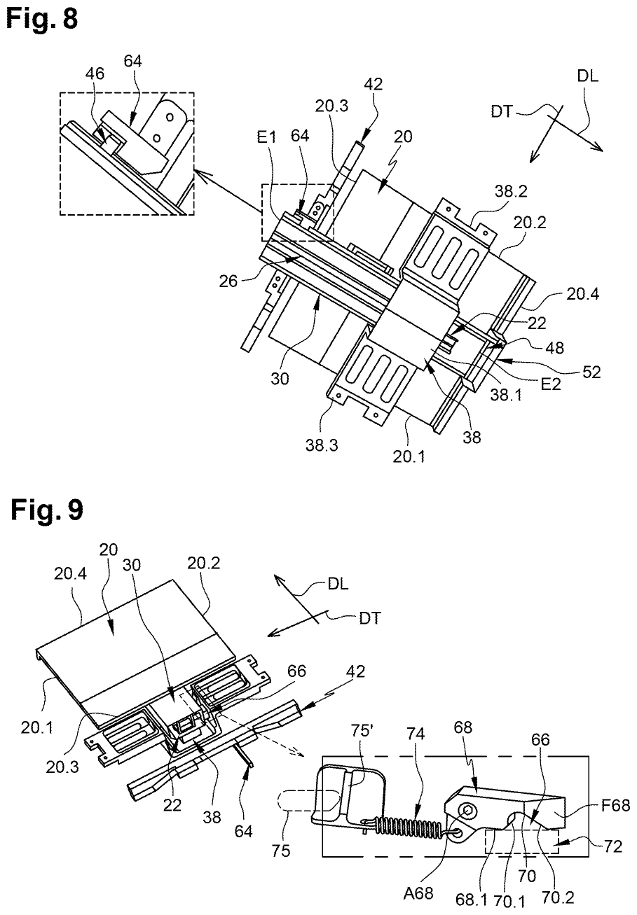

The instrument panel 16 comprises at least one substantially horizontal mobile tray 20 and at least one guide system 22 connecting the mobile tray 20 and the instrument panel 16, said guide system 22 being configured to enable the mobile tray 20 to be moved in a direction parallel to the longitudinal direction DL, substantially horizontally, between a retracted position visible in FIG. 4A and FIG. 8 and a deployed position visible in FIG. 4B and FIG. 9.

According to one arrangement, the mobile tray 20 has a substantially horizontal upper face F20, a lower face F20′ parallel to the upper face F20, lateral right-hand and left-hand edges 20.1, 20.2, substantially parallel to one another and to the longitudinal direction DL, and front and rear edges 20.3, 20.4 substantially parallel to one another and to the transverse direction DT. The rear edge 20.4 is offset toward the tail end relative to the front edge 20.3. The mobile tray 20 comprises a plane of symmetry PS parallel to the longitudinal direction DL, substantially perpendicular to the upper and lower faces F20, F20′, parallel to the lateral right-hand and left-hand edges 20.1, 20.2 and equidistant therefrom.

According to one embodiment, the mobile tray 20 comprises a rim 24 located in the region of the rear edge 20.4, protruding relative to the lower face F20′.

The mobile tray 20 and its rim 24 form an integral part made of plastics material, for example.

According to one configuration, each guide system 22 is positioned below the mobile tray 20.

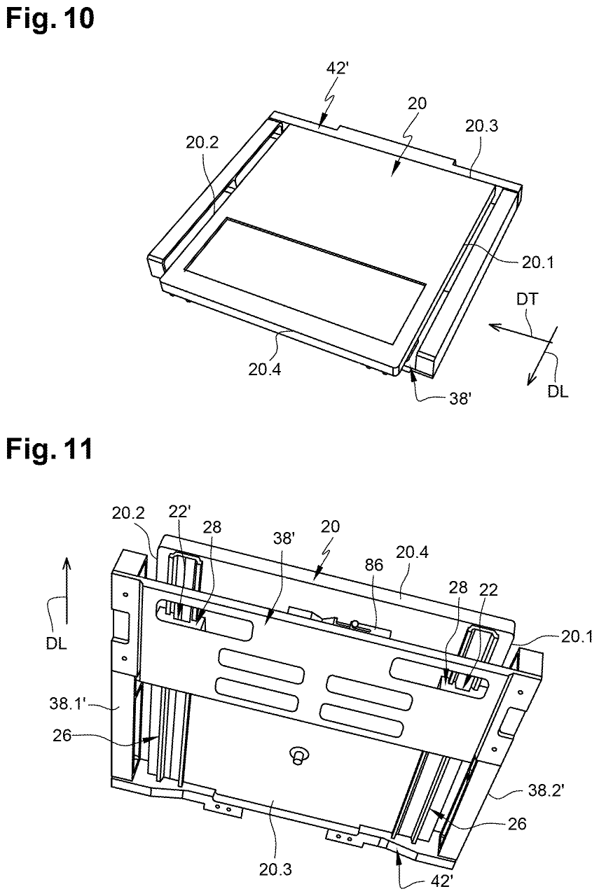

According to a first embodiment visible in FIGS. 2 to 9, the instrument panel 16 comprises a single guide system 22 positioned in the region of the plane of symmetry PS. According to a second embodiment visible in FIGS. 10 to 12, the instrument panel 16 comprises a plurality of guide systems 22 positioned symmetrically relative to the plane of symmetry PS. According to one configuration, the instrument panel 16 comprises first and second guide systems 22, 22′ respectively in the vicinity of the lateral right-hand and left-hand edges 20.1, 20.2.

According to one embodiment which is visible, in particular, in FIG. 3, each guide system 22, 22′ comprises a rail 26, which has two side portions 26.1, 26.2 which are flared, and which is integral with a first element, from amongst the mobile tray 20 and the instrument panel 16, and a groove 28 which has a shape which is complementary to that of the rail 26 (complementary in particular to those of the first and second side portions 26.1, 26.2 of the rail 26) to enable said rail to slide in the groove 28 in a direction parallel to the longitudinal direction DL, the groove 28 being integral with a second element which is different from the first element, from amongst the mobile tray 20 and the instrument panel 16. According to one arrangement, the rail 26 is integral with the mobile tray 20 and the groove 28 is integral with the instrument panel 16. According to this arrangement, each rail 26 extends over the entire length of the mobile tray 20 (dimension between the front and rear edges 20.3, 20.4) which contributes to the stiffening of the mobile tray 20. According to one configuration, the rail 26 and the groove 28 comprise a coating or are produced from a material promoting the sliding of the rail 26 in the groove 28.

According to one embodiment visible in FIGS. 2 to 9, the mobile tray 20 comprises a hollow longitudinal member 30 which is fixed below the mobile tray 20 and positioned in the region of the plane of symmetry PS. The hollow longitudinal member 30 comprises an upper wall 30.1 which is fixed to the mobile tray 20 and a lower wall 30.2 below which is fixed the rail 26 of the guide system 22. This hollow longitudinal member 30 makes it possible to stiffen the mobile tray 20 in the longitudinal direction DL. The hollow longitudinal member has a length (dimension in the longitudinal direction DL) which is greater than or equal to that of the mobile tray 20 (dimension between the front and rear edges 20.3, 20.4).

According to one arrangement, the hollow longitudinal member 30 comprises a front end E1 located in front of the front edge 20.3 of the mobile tray 20 and a rear end E2 located approximately in the region of the rear edge 20.4 of the mobile tray 20.

According to one configuration visible in FIG. 5, the hollow longitudinal member 30 comprises a first U-shaped bracket 32 which has a first base 32.1 corresponding to the upper wall 30.1 of the hollow longitudinal member 30 and first side portions 32.2, 32.3 and a second U-shaped bracket 34 which has a second base 34.1 corresponding to the lower wall 30.2 of the hollow longitudinal member 30 and second side portions 34.2, 34.3 positioned between the first side portions 32.2, 32.3 of the first U-shaped bracket 32, the first and second U-shaped brackets 32, 34 being nested in one another so as to form the hollow longitudinal member 30 and held assembled together by fixing elements.

Naturally the invention is not limited to this configuration for the hollow longitudinal member 30.

According to one embodiment visible in FIG. 3, the instrument panel 16 has a lower face F16 which comprises a housing 36 dimensioned to house the mobile tray 20 in the retracted position. In addition, the instrument panel 16 comprises an omega-shaped tray support 38. This tray support 38 comprises a central U-shaped part 38.1 which is configured to house the hollow longitudinal member 30, and first and second side portions 38.2, 38.3 which are configured to be placed against the lower face F16 on either side of the housing 36 and connected to the instrument panel 16 by fixing elements 40. According to this embodiment, the guide system 22 is interposed between the hollow longitudinal member 30 and the tray support 38, the groove 28 being integral with the central U-shaped part 38.1.

According to one manufacturing mode, the tray support 38 is obtained by molding.

In addition to the tray support 38, the instrument panel 16 comprises a fixed cross-member 42 which is fixed below the lower face F16 of the instrument panel 16 substantially parallel to the front edge 20.3 of the mobile tray 20.

According to one configuration, the tray support 38 and the fixed cross-member 42 are two separate and detached elements.

According to a second embodiment visible in FIGS. 10 to 12, the instrument panel 16 has a substantially planar lower face and comprises a tray support 38′ substantially parallel to the lower face of the instrument panel 16, spaced apart therefrom by a distance which makes it possible to house the mobile tray 20 in the retracted position, and right-hand and left-hand longitudinal members 38.1′, 38.2′ substantially parallel to one another and to the longitudinal direction DL, positioned on either side of the mobile tray 20 and connecting the tray support 38′ and the instrument panel 16. According to this second embodiment, each groove 28 of the guide system 22, 22′ is connected to the tray support 38′. In addition, the instrument panel 16 comprises a fixed cross-member 42′ which is fixed below the lower face of the instrument panel 16 and substantially parallel to the front edge 20.3 of the mobile tray 20 and/or connected to the right-hand and left-hand longitudinal members 38.1′, 38.2′.

Naturally the invention is not limited to these first and second embodiments for the tray support 38′.

Whatever the embodiment, the instrument panel 16 comprises:
at least one lower face F16,
at least one mobile tray 20 which is configured to be displaced between a retracted position in which the mobile tray 20 is positioned virtually integrally below the lower face F16 of the instrument panel 16 and a deployed position in which the mobile tray 20 protrudes relative to the instrument panel 16,
at least one tray support 38, 38′ which is connected to the instrument panel 16 on either side of the mobile tray 20, the lower face F16 of the instrument panel 16 and/or the tray support 38, 38′ being configured to house the mobile tray 20 at least in the retracted position,
at least one guide system 22, 22′ which is positioned below the mobile tray 20 and interposed between this mobile tray and the tray support 38, 38′.

According to one embodiment, the instrument panel 16 comprises at least one locking/unlocking system 44 which is configured to hold the mobile tray 20 in at least one position, from amongst the deployed portion and the retracted position.

According to one configuration, the locking/unlocking system 44 is configured to hold the mobile tray 20 alternately in the deployed position and in the retracted position.

According to a first embodiment visible in FIGS. 2 to 9, in the presence of a hollow longitudinal member 30, the locking/unlocking system 44 is substantially positioned therein.

According to this first embodiment, the locking/unlocking system 44 comprises a bolt 46 which is integral with the mobile tray 20 and mobile in a locking/unlocking direction parallel to the transverse direction DT between the extended and returned positions and a control unit 48 configured to control the position of the bolt 46.

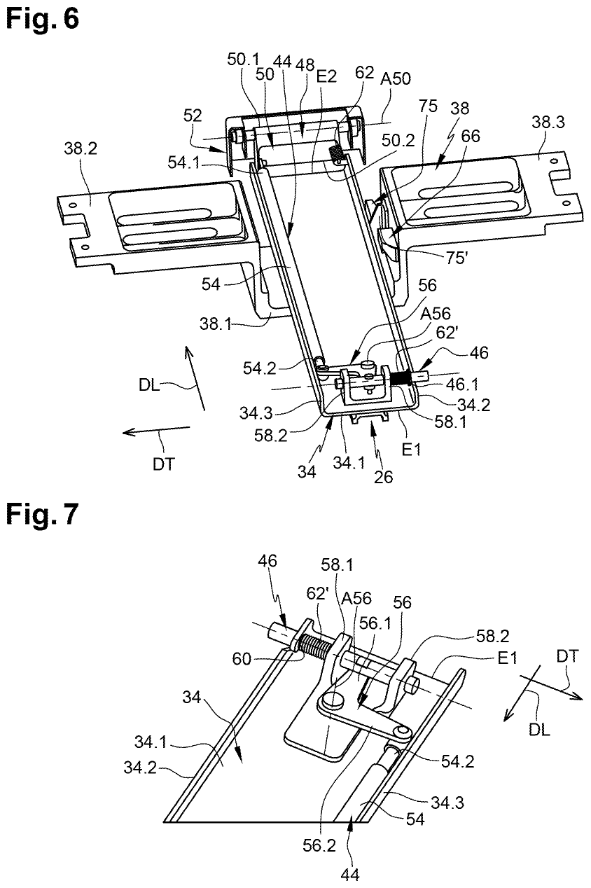

According to an arrangement visible in FIGS. 6 and 7, the bolt 46 is positioned in the region of the front end E1 of the hollow longitudinal member 30. In addition, the control unit 48 comprises:
a handle 50 which has a first edge 50.1 connected via a first pivot axis A50 parallel to the transverse direction DT to a cover 52 which is integral with the rear end E2 of the hollow longitudinal member 30 and a second edge 50.2 remote from the first edge 50.1 and substantially parallel thereto,
a connecting rod 54 which has a first end 54.1 connected to the second edge 50.2 of the handle 50 and a second end 54.2,
an L-shaped return member 56 which pivots about a second pivot axis A56 substantially perpendicular to the longitudinal and transverse directions DL, DT, and which has a first branch 56.1 connected to the bolt 46 and a second branch 56.2 connected to the second end 54.2 of the connecting rod 54.

The hollow longitudinal member 30 comprises first and second longitudinal side portions 58.1, 58.2 supporting the bolt 46 and enabling it to be moved in the locking/unlocking direction.

The hollow longitudinal member 30 has at least one through-hole 60 to enable the bolt 46 to pass through.

According to one arrangement, when the second edge 50.2 of the handle 50 approaches the cover 52, the bolt 46 moves from the extended position toward the returned position. In the reverse direction when the second edge 50.2 of the handle 50 moves away from the cover 52, the bolt 46 moves from the returned position toward the extended position.

The locking/unlocking system 44 comprises at least one spring 62 to hold the bolt in the extended position. According to one arrangement, the locking/unlocking system 44 comprises a tension spring 62 connecting the hollow longitudinal member 30 and the second edge 50.2 of the handle 50 and/or a compression spring 62′ located around the bolt 46 and interposed between a flange 46.1 integral with the bolt and the first longitudinal side portion 58.1 supporting the bolt 46.

Naturally the invention is not limited to this embodiment for the control unit 48.

According to one embodiment visible in FIGS. 8 and 9, the locking/unlocking system 44 comprises a first stop 64 (or a first housing) integral with the instrument panel 16, more particularly the fixed cross-member 42, and configured to cooperate with the bolt 46 when the mobile tray 20 is in the retracted position in order to immobilize said mobile tray 20 in translation. The first stop 64 (or the first housing) and the bolt 46 are configured such that when the bolt 46 is in the extended position and located in front of the first stop 64 (or the first housing) the mobile tray 20 is immobilized in the retracted position, while when the bolt 46 is in the returned position the mobile tray 20 can move between the retracted position and the deployed position.

In addition, the locking/unlocking system 44 comprises a second housing 66 (or a second stop) integral with the tray support 38 and configured to cooperate with the bolt 46 in the extended position when the mobile tray 20 is in the deployed position. The second housing 66 (or the second stop) and the bolt 46 are configured such that when the bolt 46 is in the extended position and located in the second housing 66 (or to the rear of the second stop) the mobile tray 20 is immobilized in the deployed position, while when the bolt 46 is in the returned position the mobile tray 20 can move between the deployed position and the retracted position.

According to one embodiment visible in FIG. 9, the locking/unlocking system 44 comprises a catch 68 which is configured to pivot about a third pivot axis A68 parallel to the transverse direction DT. This catch 68 has a lower edge 68.1 which comprises a hollow notch 70. In addition to the catch 68, the locking/unlocking system 44 comprises a stop 72. The catch 68 can pivot about the third pivot axis A68, between a contact position in which the lower edge 68.1 of the catch 68 is in contact with the stop 72 such that the notch 70 forms the second housing 66 with the stop 72, and a spaced-apart position in which the lower edge 68.1 of the catch 68 is spaced apart from the stop 72 and enables the bolt 46 to leave the second housing 66. The locking/unlocking system 44 also comprises at least one spring 74 which is configured to pivot the catch 68 about the third pivot axis A68 toward the contact position and to hold it in this position.

The notch 70 has a straight edge 70.1 which is substantially perpendicular to the lower edge 68.1 and which forms a stop blocking the bolt 46, and an inclined edge 70.2 which is offset toward the front relative to the straight edge 70.1. This inclined edge 70.2 is configured to enable the bolt 46 to push the catch 68 into the spaced-apart position counter to the spring 74.

The notch 70, more particularly the angle of the inclined edge 70.2, and the spring 74, more particularly its stiffness, are configured such that the bolt 46 is blocked in the second housing 66 when a force exerted on the mobile tray 20 urging it to move into the retracted position is less than a given threshold, and that the bolt 46 pushes the catch 68 into the spaced-apart position and leaves the second housing 66 when a force exerted on the mobile tray 20 urging it to move into the retracted position is greater than or equal to the given threshold.

According to one embodiment, the catch 68 comprises a beveled face F68 which is configured to push the bolt 46 from the extended position toward the returned position when the mobile tray 20 is moved toward the deployed position and the bolt 46 slides against the beveled face F68. This beveled face F68 enables the introduction of the bolt 46 into the second housing 66 without the control unit 48 being actuated.

In addition to the catch 68, the locking/unlocking system 44 can comprise a pair of stops 75, 75′ respectively integral with the hollow longitudinal member 30 and the tray support 38, and configured to come into contact with one another when the mobile tray 20 is in the deployed position.

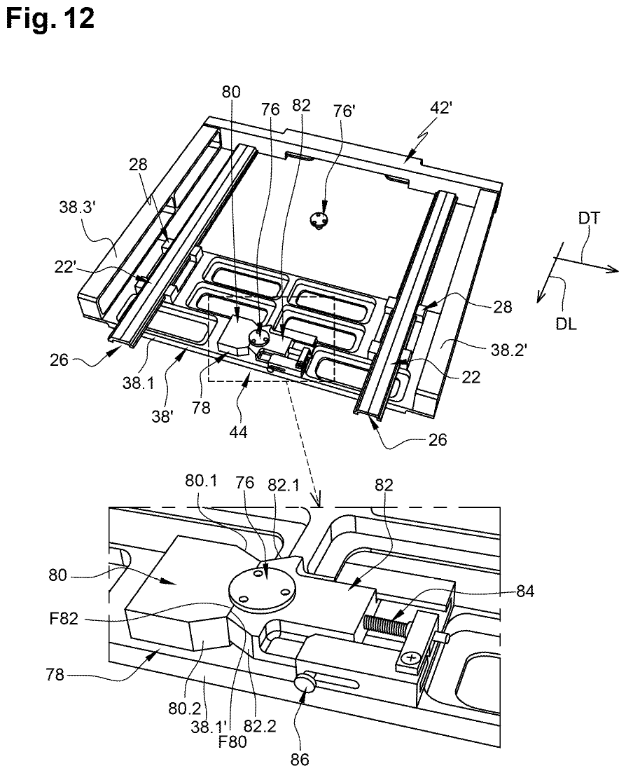

According to a second embodiment visible in FIG. 12, the locking/unlocking system 44 comprises at least one pin 76 which is integral with the mobile tray 20 and which protrudes relative to the lower face F20′ and a jaw 78 which is integral with the tray support 38′, said jaw 78 being configured to occupy a closed state in which the jaw 78 holds the pin 76 and immobilizes the mobile tray 20, and an open state in which the jaw 78 does not hold the pin 76 and enables the mobile tray 20 to be moved. According to one configuration, each pin 76 is positioned in the region of the plane of symmetry PS.

According to one arrangement, the locking/unlocking system 44 comprises first and second pins 76, 76′ offset in the longitudinal direction DL, the first and second pins 76, 76′ and the jaw 78 being positioned such that the first pin 76 is held in the jaw 78 when the mobile tray 20 is in the retracted position and the second pin 76′ is held in the jaw 78 when the mobile tray 20 is in the deployed position.

According to one configuration, the jaw 78 comprises first and second jaw plates 80, 82 which are offset in the transverse direction DT and positioned on either side of the plane of symmetry PS, at least the second jaw plate 82 being mobile between a first position corresponding to the closed state of the jaw 78 in which the second jaw plate 82 is in contact with the first jaw plate 80 and a second position corresponding to the open state of the jaw 78 in which the second jaw plate 82 is spaced apart from the first jaw plate 80.

In addition, the locking/unlocking system 44 comprises at least one spring 84 which is configured to hold the second jaw plate 82 in the first position corresponding to the closed state of the jaw 78 and a control unit 86 enabling the second jaw plate 82 to be spaced apart from the first jaw plate 80.

The first and second jaw plates 80, 82 respectively comprise first and second opposing contact faces F80, F82 in contact with one another in the closed state. According to one embodiment, the first and second contact faces F80, F82 comprise first and second notches forming, when the first and second jaw plates 80, 82 are in contact with one another, a housing configured to house the first or second pin 76, 76′ and to immobilize said first or second pin.

According to one arrangement, the jaw 78 and the spring 84 are configured such that the first or second pin 76, 76′ is immobilized in the jaw 78 when a force exerted on the mobile tray 20 urging it to move is less than a given threshold, and that the first or second pin 76, 76′ pushes the second jaw plate 82 into the second position and the jaw into the open state when a force exerted on the mobile tray 20 urging it to move is greater than or equal to the given threshold.

According to one configuration, the jaw 78, and more particularly each of the first and second contact faces F80, F82, have beveled shapes 80.1, 80.2, 82.1, 82.2 which promote the introduction of a pin 76. 76′ into the jaw 78 between the first and second jaw plates 80, 82 in the first and second notches.

Naturally the invention is not limited to these first and second embodiments for the locking/unlocking system 44.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft instrument panel comprising:
at least one lower face;
at least one mobile tray configured to move parallel to a longitudinal direction between a retracted position in which the at least one mobile tray is virtually integrally positioned below the at least one lower face of the aircraft instrument panel and a deployed position in which the at least one mobile tray protrudes relative to the aircraft instrument panel;
at least one tray support connected to the aircraft instrument panel on either side of the at least one mobile tray, the at least one lower face of the aircraft instrument panel, or the at least one tray support, or both configured to house the at least one mobile tray at least in the retracted position;
at least one guide system positioned below the at least one mobile tray and interposed between the at least one mobile tray and the at least one tray support; and,
at least one locking/unlocking system configured to hold the at least one mobile tray alternately in the deployed position and in the retracted position,
wherein the locking/unlocking system comprises:
a bolt configured to move between an extended position and a returned position and integral with the at least mobile tray;
a control unit configured to control a position of the bolt;
at least one first spring to hold the bolt in the extended position;
a housing or a stop integral with the at least one tray support and configured to cooperate with the bolt in the extended position when the at least one mobile tray is in the deployed position;
a catch which has a lower edge provided with a notch and a second stop, the catch pivoting between a contact position in which the lower edge of the catch is in contact with the second stop such that the notch forms the housing or the stop integral with the at least one tray support and a spaced-apart position in which the lower edge of the catch is spaced apart from the second stop, and,
at least one second spring configured to pivot the catch toward the contact position and to hold the catch in the contact position.

2. The aircraft instrument panel as claimed in claim 1, wherein the at least one mobile tray comprises a plane of symmetry and the aircraft instrument panel comprises a single guide system positioned in a region of the plane of symmetry or a plurality of guide systems positioned on either side of the plane of symmetry.

3. The aircraft instrument panel as claimed in claim 1, wherein each guide system comprises a rail integral with a first element, selected from the at least one mobile tray and the at least one tray support, and a groove which has a shape which is complementary to a shape of the rail to enable the rail to slide in the groove, the groove integral with a second element selected from the at least one mobile tray and the at least one tray support and which is different from the first element.

4. The aircraft instrument panel as claimed in claim 2, wherein the aircraft instrument panel comprises a single guide system positioned in the region of the plane of symmetry and the aircraft instrument panel comprises a hollow longitudinal member which is fixed below the at least one mobile tray in the region of the plane of symmetry, the single guide system interposed between the hollow longitudinal member and the at least one tray support.

5. The aircraft instrument panel as claimed in claim 4, wherein the locking/unlocking system is positioned in the hollow longitudinal member.

6. The aircraft instrument panel as claimed in claim 1, wherein the locking/unlocking system further comprises an additional stop or an additional housing integral with the aircraft instrument panel and configured to cooperate with the bolt in the extended position when the at least one mobile tray is in the retracted position.

7. The aircraft instrument panel as claimed in claim 1, wherein the catch comprises a beveled face configured to push the bolt from the extended position toward the returned position.

8. The aircraft instrument panel as claimed in claim 1, wherein the notch and the at least one first spring are configured such that the bolt is blocked in the housing when a force exerted on the at least one mobile tray urging the at least one mobile tray to move is less than a given threshold, and
wherein the bolt pushes the catch into the spaced-apart position and leaves the housing when a force exerted on the at least one mobile tray urging the at least one mobile tray to move is greater than or equal to the given threshold.

9. An aircraft comprising:
at least one aircraft instrument panel as claimed in claim 1.
